(19) United States
(12) Patent Application Publication
(10) Pub. No.: US 2008/0147412 A1
(43) Pub. Date: Jun. 19, 2008

(54) Computer voice recognition apparatus and method for sales and e-mail applications field

(75) Inventors: Jack B. Shaw, Johnstown, PA (US); David A. Smith, Johnstown, PA (US)

Correspondence Address: BANNER & WITCOFF, LTD., 1100 13th STREET, N.W., SUITE 1200, WASHINGTON, DC, 20005-4051, US

(73) Assignee: Vaastek, Inc., Johnstown, PA (US)

(21) Appl. No.: 11/641,035

(22) Filed: Dec. 19, 2006

(51) Int. Cl. G10L 15/00

(52) U.S. Cl. 704/275; 704/E15.001

(57) ABSTRACT

The present invention relates to an apparatus and method for computer voice-recognition and in particular, computer voice recognition for user voice feedback systems for sales and E-mail applications.

Aspects relate to an apparatus and method for computer voice-recognition and in particular, computer voice recognition for user voice feedback systems for sales and E-mail applications.

### BACKGROUND

Computer voice recognition and dictation systems have been recently used in the art for limited purposes. In prior art systems, computers are adapted to recognize spoken words of a particular user and to translate the spoken words via speech-recognition software into written words in the form of text. The written text information is then output on a computer monitor in a word processing program. The document thus generated may then be printed or stored in computer memory. Thus, many computer speech recognition systems have been used exclusively as dictation devices in which a user may type words into a computer by speaking the words rather than having to manually type in words on a computer keyboard.

Computer voice recognition and dictation systems have been most commonly applied in the medical and legal fields in which information is dictated into a microphone by a user in the form of spoken words. The computer contains speech-recognition software that recognizes the spoken words of the user and produces the written text form of the spoken words on a computer screen. In the medical field, physicians dictate patient information such as a patient history, in-patient progress or findings on a physical examination of the patient into the microphone of a computer and the computer generates the dictated patient information in written form on the computer monitor. In the legal setting, attorneys and paralegals may similarly dictate any information that would ordinarily be typed into the computer. This might include briefs, letters, or e-mail. The computer performs the “typing” and produces a written document containing a written transcript of the dictated words.

In addition to dictation, home security systems, climate control, and other systems in the home have been controlled through the use of computer voice recognition systems. For example, if a user wishes to turn down the heat in the house to a specified level, the user would issue a verbal command into a microphone on a computer to turn the heat down to the specified level. The computer voice recognition system through speech-recognition software would process the received verbal command and respond to the verbal command by turning down the heat as requested.

Such voice recognition systems have provided users with the ability to produce written documents and perform household regulatory tasks such as temperature control in a “hands-free” manner. Dictation and control of the home is accomplished through a strictly one-way process in which the computer receives verbal commands from a user and responds by performing the requested task. However, such systems do not provide verbal feedback to the user as needed. For example, in these systems, a user cannot retrieve information from a computer database response to a verbal request. Nor can a user receive requested data from a computer in audio form. Furthermore, there is no computer voice-recognition system in which the computer provides audio information responsive to a user's verbal request in a format that would ensure easy comprehension by the user.

In prior art systems, users with unique manners of speech, regional accents, dialects, foreign accents, speech impediments or the like have faced difficulty in voice recognition. Although some prior art systems have attempted to “train” a voice recognition system to recognize different speech patterns and sounds, there have been no systems to ensure that the user understands any speech generated by the system. Rather, prior art systems that produce speech do so in a computer generated voice. Hence a user who is unfamiliar with the speech pattern provided by the computer generated speech would not understand the pronunciation provided by the computer. This results in loss of efficiency of the process.

Such a system is disclosed in U.S. Pat. No. 6,581,782 (Reed) which discloses a system and method for sorting mail items in which an addressee's name is wirelessly transmitted to a computer workstation. A data record corresponding to the addressee's name is returned to the user from a database on a computer display or via a speaker in a headset. However, these systems produce computer synthesized speech which may be incomprehensible to the mail sorter. This problem is compounded if the mail sorter speaks in a unique way (e.g., local dialects) such that standard computer “speech” might be hard to understand. In addition, the prior art systems suffer from prohibitive costs because the use of synthesized speech is expensive.

Also, the prior art systems are unable to accurately identify all necessary speech input. This is due in part to the fact that the prior art systems are non-selective in the variation of voice input. Accuracy is thus impaired in the prior art systems.

Other systems include systems for determining inventory in warehouses or stock rooms such as the commercial product Vocognition's Warehouse Execution System. While collecting data, an operator wears a headset with a microphone connected to a waist mounted terminal. The terminal asks the operator questions or provides instructions in synthesized speech. The operator speaks responses that are stored by the terminal for import into a database or spreadsheet software package. This system can only populate databases, and does not provide feedback to the user.

Voxware's Voice Logistics integrates with industry standard or customized warehouse management systems and a wireless network. A networked wearable computer and headset issues workers a series of voice prompts as instructions, and they speak a vocabulary of responses as the tasks progress. Voice Logistics takes into account many variables, such as a worker's position and abilities.

Other systems are directed to E-mail such as Research In Motion's Blackberry. The Blackberry does not use speech recognition, but instead, a tiny keyboard.

Coolsoft's Speak-To-Mail has Speak-to-Mail Speech Recognition. A user can dictate and send E-mails using state of the art voice recognition technology. Speak-to-Mail Speech Recognition can read the contact list from one's E-mail program and will display an E-mail template. Users choose recipients, dictate E-mail, and send it through the default E-mail program entirely by speech recognition. Speak-to-Mail includes a natural language model that lets the user set up E-mail with a single sentence, through speech recognition technology from Microsoft.

The systems described above have the common problem of voice recognition by computer and by the user. Although the voice recognition systems are being improved, none alleviate the problems of strong dialects, accents, and the like whereby the computer does not recognize the user's words. Moreover, none alleviate the problems of the computer synthesized voice not being recognizable to persons where English is not their native language.

### SUMMARY

The present invention relates to computer voice recognition for user voice feedback systems for sales and E-mail applications.

In a sales environment, particularly a sales floor environment, a salesperson will often be queried about inventory. Aspects of the invention allow a salesperson to speak into a microphone, such as a hands-free microphone, and request inventory information about a particular product. A computer system accesses inventory information and then relays information concerning inventory back to the salesperson, in the salesperson's own voice.

Thus, the input voice information is converted from speech to data using speech recognition software, for example, in a Speech Recognition Engine (SRE). The input voice information is compared to stored data in the database. Information or data relating to the inquiry is obtained from the database. The desired information or data is output in the form of speech, for example, by a data output engine. The output speech data is output to the user, for example, through a Voice User Interface (VUI). The output speech data is in the same voice as the input voice data to optimize clarity and comprehension.

E-mail is a very popular means to convey information. However, E-mail must typed or “dictated” such as with voice recognition software. The E-mail is then read for accuracy and transmitted. Often E-mail needs to prepared and E-mailed from locations that do not allow easy access to a computer screen for reviewing dictated E-mails and transmitting prepared E-mails. In aspects of the invention, a user “dictates” an E-mail into a microphone, preferably a hands free microphone. The E-mail is drafted by the computer and then read back to the user in the user's own voice. The E-mail can be then transmitted or corrected as necessary.

### BRIEF DESCRIPTION OF THE DRAWINGS

FIG. 1 is a block diagram illustrating an aspect of the invention relating to sales inventory.

FIG. 2 is a block diagram illustrating an aspect of the invention relating to E-mail.

### DETAILED DESCRIPTION

Aspects of the invention relate to computer voice recognition for user voice feedback systems for sales and E-mail applications.

It was discovered that a system could be developed using information that is constantly changing, such as an inventory system in a storeroom or warehouse. Products are continually being removed from and replaced with like or different products. Aspects of the invention provide a system and method for providing up-to-date inventory information to a user in a “hands-free” manner.

In addition, a user may require information expeditiously while the user is otherwise indisposed. For example, if a user is engaged in an activity that requires his continuous attention, the user may be unable to suspend that activity in order to obtain or request the needed information. Such a user can be a floor salesperson who is needed on the floor to interact with customers. When a salesperson becomes inaccessible or disappears for a time, customers may become irritated and walk out of the store. Thus, the present invention provides a computer system in which a user may efficiently obtain the needed information without the need for the user to divert his attention or suspend his present activity.

The user can obtain real-time information regarding inventory in a warehouse such as whether a product is available, how many of the product is available, whether there are any holds on the products, and the like. The user can also find out price and pricing discounts such as three for the price of two. Moreover, if an inventoried item is not available, the system can provide expected dates for arrival, whether the product has been discontinued, and/or equivalent products that are available.

In one aspect, a hands-free speech recognition system allows the user to access inventory data via a headset microphone and PDA. This system provides users with the power of real-time hands-free information access and provides the information in each user's own voice.

The system is particularly useful in a retail environment where hands-free access to information highly increases efficiency. For example, a sales person would not need to go back into the storeroom to view inventory or take time out to type an inventory request into a computer or PDA and then read the result. This allows sales personnel, for example, to spend more time addressing customer needs at the point of sale providing more intimate customer service and greater customer satisfaction. In addition, sales-floor labor costs can be reduced and product turnover can be increased by providing information quickly.

The system easily integrates with existing inventory systems. Inventory information may be obtained for a back storeroom or warehouse that is part of, or adjacent to, a retail center. Alternatively, or in addition, the inventory information may be obtained from an off site or central warehouse. The information may include standard times to transfer inventory from an off site warehouse to the retail center.

The system comprises headsets, PDA's or other portable electronic devices, and servers that combined deliver audio information based on verbal commands.

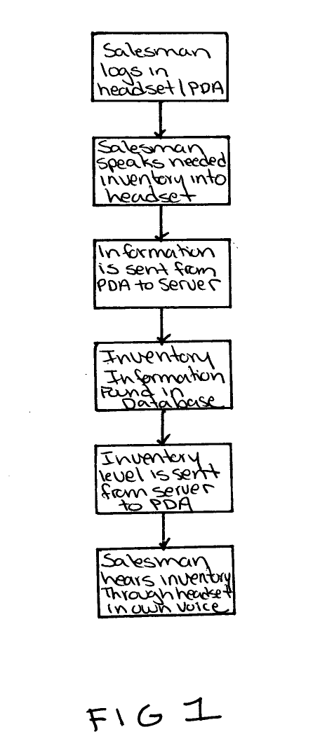

Attention is drawn to FIG. 1. A salesman logs into a secure network. The salesman speaks needed inventory information into a headset. The requested inventory information is sent from a PDA to a server. The inventory information is found in a database. The inventory information is sent from the server to the PDA. The salesman hears the inventory information through the headset in his own voice.

During operation of the system in the inventory embodiment, the user speaks a product into a microphone. The product may be identified by its name, manufacturer, product number may be a product name, or a combination thereof. For example, the item may be a general item such as a 40 watt light bulb for which there are several manufacturers. Or the item may be specific such as Campbell's Chicken Noodle Soup.

The input speech from the user is input through the VUI 100 and processed and digitized in the SRE 110. The requested product information is sent to the database where the product information is matched with corresponding inventory data available in the database. The corresponding inventory data in the database is associated with desired output data, in this case, information on inventory.

The application 120 and data output engine 140 outputs the inventory data as speech data. This may be accomplished in any suitable way. The inventory data is sent to the VUI 100 and may be delivered to the user through a speaker or headset. Additionally, the output is in the user's voice to ensure complete comprehension by the user.

The system as applied in the sales floor example further enables close monitoring and quality control of all aspects of the activity. Moreover, the monitoring or quality control may be accomplished remotely. Information pertaining to the operation of the system, including training of users, may be wirelessly transmitted to a server and further transmitted to a remote site for further evaluation. This information may also be filtered (e.g., noise cancellation or selected frequency response) such that only certain designated information is transmitted while extraneous information is omitted. The information may further be compressed for higher throughput over a given bandwidth.

The microphone may be connected to a headset, for example. Alternatively, the microphone may be a stand-alone microphone. For added convenience and portability, the microphone should be wireless. The input speech signal is received through the VUI 100 and processed and digitized in the SRE 110. The speech signal is converted to data which is then compared in the database 130. The associated information is then output via the data output engine 140 to the delivery person via the VUI 100 in the form of speech. The speech output may be provided to the sales person via any number of means, for example, a headset or speaker. Additionally, the speech output may be provided in the delivery person's voice to maximize comprehension.

Co-pending application Ser. No. 11/148,443, hereby incorporated by reference in its entirety, describes a method and system for automating a procedure in which a user may access computer information in a “hands-free” manner while ensuring the integrity and comprehensibility of the returned information from the system. Ser. No. 11/148,443 particularly describes the use of the system for obtaining information pertaining to routing or sorting of the mail such as, but not limited to, carrier route information or post office box information. That is, a mail sorter speaks the address on a letter into the input device and receives the desired information as output in the mail sorter's voice. This application also mentions the use of the system to obtain other stored information such as bible verses.

The input voice information is converted from speech to data using speech recognition software, for example, in a Speech Recognition Engine (SRE). The data is converted to text. The text is outputted in the form of speech, for example, by a data output engine. The output speech data is output to the user, for example, through a Voice User Interface (VUI). The output speech data is in the same voice as the input voice data to optimize clarity and comprehension.

The data may further be stored in a database. The input voice information is compared to stored data in the database. Matching data obtained from the database may be associated with desired information or data in the database. The desired information or data is output in the form of speech, for example, by a data output engine. The output speech data is output to the user, for example, through a Voice User Interface (VUI). The output speech data may be in the same voice as the input voice data to optimize clarity and comprehension.

Ser. No. 11/148,443 further describes that a Voice User Interface (VUI) is the interface between the user and the computer system for voice recognition. VUI may include a headset with a microphone in which the user may speak into the microphone or listen to output from the computer through the earpiece of the headset. Alternatively, the user may listen to output from the computer through speakers. The headset may include only one earpiece so that the user may be able to clearly hear other sounds. In this way, safety and efficiency may be optimized. The VUI may be a mobile unit for receiving voice input from the user and transmitting signals wirelessly to a base station or a server in a wireless LAN. Further, multiple users may be transmitting signals simultaneously.

A Speech Recognition Engine (SRE) receives the signal from the VUI. The SRE may be located on a server, for example. Alternatively, the SRE may be located at the mobile client. The SRE receives speech input from the VUI and processes the information in accordance with the application.

Upon receiving the speech input, the SRE creates an acoustic file where the signal may be further optimized through noise reduction and filtering such that ambient noise may be reduced or eliminated. The speech input is converted to phonemes (i.e., speech sounds perceived to be single distinctive sounds). This conversion may be accomplished, for example, through application of a probabilistic function in which the system may use statistical modeling to determine the most likely phoneme based on a previous phoneme. The Markov model is one example of a probabilistic function that may be used in determining phonemes. A word is thus determined which in turn enables the determination of a phrase.

Data lookup is performed in the database based on the received information as processed by the application. Data from the database is returned based on matching the input information with the desired output. Thus, based on the verbal input of the user and received through the SRE, corresponding data is output from the database, processed by the application and converted into speech by the data output engine. The data output engine returns the speech output to the VUI which is output to the user. Output data may be returned to the user via a speaker or a headset, either of which may be wireless to enhance mobility of the user.

The audible output data provided to the user is provided in the voice of the user.

In this way, users who may be unfamiliar with the standard computer generated speech will be able to understand the audible output. For example, a user with a regional accent, such as an accent from the Southern states or from a New England state, may have difficulty understanding computer-generated speech which might be provided with standard pronunciation. Such a user may be familiar with persons speaking in his/her own native pronunciation and might have difficulty understanding the audible output from the computer.

Likewise, users from non-English speaking countries who have learned English as a foreign language might have difficulty in listening comprehension of the English language due to inherent problems in understanding foreign speech. Part of the problem of sub-optimal listening comprehension might result from the unfamiliarity with the accent of native speakers. The present invention provides a voice-recognition system in which the audible output speech is in the voice of the user. Thus, the user would have no problem in comprehending the output speech because the output speech is in the user's own voice.

Also, because the output speech is in the user's own voice, the user may not even be required to speak any particular language. For example, a user in the United States might not even be able to speak English. However, the non-English speaking user in the United States would still be able to use the present system effectively and efficiently and have no problems comprehending the audible output of the system. The system could easily adapt to any input speech pattern or any accent because the audible output from the computer would match the input voice (i.e., voice of the user).

The user may initially enroll in the system by executing a one-time set up procedure that trains the system to recognize the user's voice. Additionally, the enrollment process may be used to establish a unique user profile. A suitable enrollment system is described in U.S. Ser. No. 11,148,443.

Following one-time enrollment, the user may logon using any number of logon procedures. After logging on, the user may speak information into the system (e.g., via a microphone). The system recognizes and converts the input speech to data and obtains corresponding data from the database. The data thus obtained from the database is converted to speech data and output to the user (e.g., via a speaker or via headsets). The speech data output to the user may be in the same voice as the user.

The user first logs into the system and trains the system to recognize his/her voice. The training process is a one-time set up procedure that need not be repeated once completed. After the enrollment process is complete, the system may receive user identification data when the user logs onto the system (step 520). There are many effective ways of logging onto the system and any log on method may be used. For example, the system may require the user input a password through an input device, such as a keyboard, mouse, touchpad, monitor, or voice input in which the user may verbally state the proper password into a microphone or, alternatively, respond properly to a series of questions in a challenge response format. This latter technique is effective in preventing inadvertent theft of one's password since the questions are presented randomly.

Another aspect of the invention is directed to a hands-free speech recognition system which allows the user to vocally specify an E-mail address and dictate a text message for an immediate or future E-mail via a headset microphone and PDA or computer. The user's spoken words are converted into written text, alleviating the need for manual word processing or visual attention. The system then allows a user to listen to incoming E-mails in the user's own voice, dictate a response by voice, listen to and edit the dictated E-mail, and transmit the E-mail.

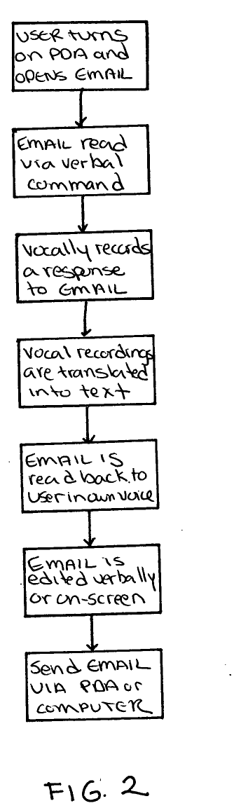

The application may be run on any suitable platform, in particular on the Windows platform for PDA's. For example, as shown in FIG. 2, a user turns on a PDA and opens the E-mail system. The E-mails are read to him in his own voice using verbal commands. The user vocally records a reply to the E-mail. The vocal recording is translated into text. The reply is read back in his own voice. The user edits the E-mail verbally or on-screen to make sure the translation process is accurate. The E-mail is then sent from the wireless PDA or after docking with a computer. Alternatively, the E-mail may be forwarded or stored using voice commands.

The system increases user productivity and provides a safer usage of PDA's while driving, for example, since the amount of time a driver is distracted by viewing a PDA is reduced or eliminated.

In the E-mail system, the user dictates an E-mail to a PDA or other electronic device. The E-mail is “written” and then read back to the user in the user's own voice. Combining verbal editing commands such as “Read”, “Write”, “Save”, “Delete”, with the SRE's ability to convert speech into content for the body of the E-mail response enables users to navigate through the familiar tasks of retrieving, reviewing, and responding to E-mail without visual feedback. For users in sales positions as well as legal, medical, and other disciplines requiring document review etc. who spend many hours behind the wheel of a car, this time can be spent productively answering questions, formulating opinions, and retrieving and sending information. The E-mail system also allows sight-impaired people to listen to their E-mails in their own voice, dictate a response, and then listen to their response in their own voice.

It is understood that the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

What is claimed is:

1. A method of obtaining inventory information using voice recognition of a user requesting the inventory information, the method comprising:
receiving a first voice input of the user, the first voice input corresponding to a product;
converting the first voice input into a first data;
identifying a second data in a database based on said first data, the second data being associated with the first data;
assembling output information from stored data based on the second data, the stored data being derived from voice input from the user;
converting the assembled output information corresponding to the second data into an audible output corresponding to the voice of the user.

2. The method of claim 1 wherein the first voice input comprises at least one of a product name, a product identification number, or category of products.

3. The method of claim 1 wherein the second data comprises information on the quantity of product.

4. The method of claim 1 wherein the second data comprises information on the expected receiving date of a product.

5. The method of claim 1 wherein the second data comprises information on related products.

6. The method of claim 1 wherein the user speaks into a microphone.

7. The method of claim 6 wherein the microphone is a hands-free microphone.

8. A system for obtaining inventory information, said system comprising:
a voice user interface for receiving a first voice input the first voice input corresponding to a product;
a speech recognition engine for converting the first voice input into a first data; an application unit for identifying second data based on said first data, said second data comprising output information associated with said the data, the output information being assembled from data stored in said database, the data stored in the database being derived from voice input from the user;
a text-to-speech engine for converting the assembled data corresponding to the second data into an audible output corresponding to the voice of the user.

9. The system of claim 8 wherein the first voice input comprises at least one of a product name, a product identification number, or category of products.

10. The system of claim 8 wherein the second data comprises information on the quantity of product.

11. The system of claim 8 wherein the second data comprises information on the expected receiving date of a product.

12. The system of claim 8 wherein the second data comprises information on related products.

13. The system of claim 8 wherein the user speaks into a microphone.

14. The system of claim 13 wherein the microphone is a hands-free microphone.

15. A method of preparing and transmitting an E-mail using voice recognition of a user preparing the E-mail, the method comprising:
dictating an E-mail using a voice input of the user;
translating the voice input into written text of the E-mail;
transmitting an audible output of the written text of the E-mail corresponding to the voice of the user; and
transmitting the written text.

16. The method of claim 15 further comprising, after transmitting the audible output, editing the written text using voice input.

17. The method of claim 15 wherein the E-mail is transmitted via a wireless device.

18. A method of retrieving and sending E-mails using voice recognition of a user, the method comprising:
reviewing incoming E-mail by transmitting an audible output of the written text of incoming E-mail corresponding to the voice of the user;
dictating an E-mail response using a voice input of the user;
translating the first voice input into written text of the E-mail;
transmitting an audible output of the written text of the E-mail corresponding to the voice of the user; and
transmitting the written text.

19. The method of claim 18 further comprising, after transmitting the audible output, editing the written text using voice input.

20. The method of claim 18 wherein the E-mail is transmitted via a wireless device.

21. A system for reviewing and preparing E-mails, said system comprising:
a voice user interface for receiving a voice input;
a speech recognition engine for converting the voice input into a written text of an E-mail;
a text-to-speech engine for converting the written text into an audible output corresponding to the voice of the user.
